(19) United States
(12) Patent Application Publication
(10) Pub. No.: US 2008/0175473 A1
(43) Pub. Date: Jul. 24, 2008

(54) DEVICE AND METHOD OF ESTIMATING IMAGE SIGNAL NOISE AND APPARATUS AND METHOD OF CONVERTING IMAGE SIGNAL USING THE SAME

(75) Inventor: Haeng-kang Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/758,239

(22) Filed: Jun. 5, 2007

(30) Foreign Application Priority Data
Jan. 19, 2007 (KR) 10-2007-0006293

(51) Int. Cl. G06T 5/50; G06T 5/40

(52) U.S. Cl. 382/172; 382/261

(57) ABSTRACT

A device and a method of estimating noise of an image signal, and an apparatus and a method of converting an image signal using the same are provided. The apparatus for converting the image signal includes a noise estimation device determining a noise level by using the minimum frame sum of absolute difference (SAD) detected from a plurality of input image fields; an interpolation filter interpolating the input image fields; and an interpolation filter control unit generating a filter coefficient control signal of the interpolation filter by using the noise level obtained by the noise estimation device. Accordingly, it is possible to effectively and accurately estimate noise of a frame based image field by providing the method of estimating the noise using the minimum frame SAD.

### CROSS-REFERENCE TO RELATED PATENT APPLICATION

This application claims priority from Korean Patent Application No. 10-2007-0006293, filed on Jan. 19, 2007, in the Korean Intellectual Property Office, the disclosure of which is incorporated herein in its entirety by reference.

### BACKGROUND OF THE INVENTION

1. Field of the Invention

The present invention relates to a device and a method of estimating noise of an image signal and an apparatus and a method of converting an image signal using the same, and more particularly, to a method and a device for effectively removing noise from an image by accurately estimating the noise of a frame based image.

2. Description of the Related Art

In general, an image such as a film for a theater movie is produced as an interlaced field image by interlacing a progressive frame image. A 3:2 pull-down format technique, or a 2:3:3:2 cadence pattern technique is employed as a method of interlacing an image. A field image obtained by the aforementioned method is referred to as a frame based field image.

When the interlaced field image is deinterlaced and recovered as the progressive frame image, the original image is interpolated using temporal interpolation that is a simple intra-interpolation technique. However, when the interlaced field image is interpolated through the temporal interpolation technique, the recovered image deteriorates due to jitter, judder, and other noise. Accordingly, in order to reduce the deterioration of the recovered image, additional processing is needed.

### SUMMARY OF EXEMPLARY EMBODIMENTS OF THE PRESENT INVENTION

The present invention provides provide a device and a method of estimating noise of an image signal so as to effectively cancel an influence of the noise during interpolation of a frame based field image and an apparatus and a method using the same.

According to an aspect of the present invention, there is provided a device for estimating noise of an image, the device including a frame sum of absolute difference (SAD) calculation unit which calculates a plurality of frame SADs by using a plurality of image fields; a minimum SAD detection unit which determines a minimum frame SAD among the plurality of frame SADs calculated by the frame SAD calculation unit; and a noise level determination unit which determines noise levels of the plurality of image fields by using the minimum frame SAD detected by the minimum frame SAD detection unit.

According to another aspect of the present invention, there is provided an apparatus for converting an image signal, the apparatus including a noise estimation device which determines a noise level by using a minimum frame SAD detected from a plurality of input image fields; an interpolation filter which interpolates the input image fields; and an interpolation filter control unit which generates a filter coefficient control signal of the interpolation filter by using the noise level obtained by the noise estimation device.

According to yet another aspect of the present invention, there is provided a method of estimating noise of an image signal, the method including calculating a plurality of frame SADs by using a plurality of image fields; determining the minimum frame SAD among the plurality of frame SADs; and determining the noise level by using the minimum frame SAD.

According to yet another aspect of the present invention, there is provided a method of converting an image signal, the method including estimating noise by using a minimum frame SAD detected by using a plurality of input image fields; and controlling an interpolation filter of the input image fields by using the estimation result of the noise.

### BRIEF DESCRIPTION OF THE DRAWINGS

The above and other aspects of the present invention will become more apparent by describing in detail exemplary embodiments thereof with reference to the attached drawings in which:

FIG. 1 illustrates a method of generating a field having a 3:2 pull-down format;

FIG. 2 is a functional block diagram illustrating a structure of an apparatus for converting an image signal;

FIG. 3 is a functional block diagram illustrating a detailed structure of a frame SAD calculation unit;

FIG. 4 is a functional block diagram illustrating a detailed structure of a minimum frame SAD detection unit;

FIGS. 5A and 5B illustrate examples of a detailed structure of a noise level determination unit;

FIG. 6 is a flowchart illustrating a method of converting an image signal according to an exemplary embodiment of the present invention;

FIG. 7 illustrates a method of converting an image using fields having a 3:2 pull-down format according to an exemplary embodiment of the method of converting an image signal; and

FIG. 8 is a graph illustrating a method of converting an image signal according to another exemplary embodiment of the present invention.

### DETAILED DESCRIPTION OF EXEMPLARY EMBODIMENTS OF THE PRESENT INVENTION

First, backgrounds of exemplary embodiments of the present invention will be briefly described.

An apparatus and a method of converting an image according to an exemplary embodiment of the present invention to be described are based on a frame based interlaced field. That is, an exemplary embodiment of the present invention is based on an interlaced field obtained by interlacing theater movie film using a 3:2 pull-down format technique or 2:3:3:2 cadence pattern technique, etc. Such frame based field should be distinguished from general TV's interlaced field.

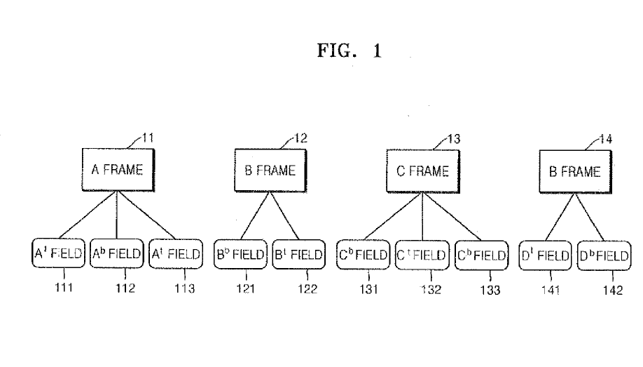

Referring to FIG. 1, a method of generating a 3:2 pull-down format field will be described. The 3:2 pull-down format is one of the interlacing methods, according to which 3 fields, 2 fields, 3 fields, 2 fields . . . are extracted from frames of a film in a row. More specifically, an A-top field (111), an A-bottom field (112), and an A-top field (113) are extracted from the A frame (11), and then, a B-bottom field (121) and a B-top field (122) are extracted from B frame. It should be noted that when a frame sum of absolute difference (SAD) is obtained between two fields selected from a field sequence, the frame SAD between the two fields having the same phase which are extracted from the same frame is less than the frame SAD between another pair of fields. The frame SAD between the two fields (e.g., 111 and 113) having the same phase which are extracted from the same frame substantially corresponds to noise such as jitter, judder, and the like. Accordingly, it is possible to accurately estimate the noise of the image signal by using the frame SAD between the two fields having the same phase which are extracted from the same frame.

Now, exemplary embodiments of the present invention will be described in detail with reference to the attached drawings.

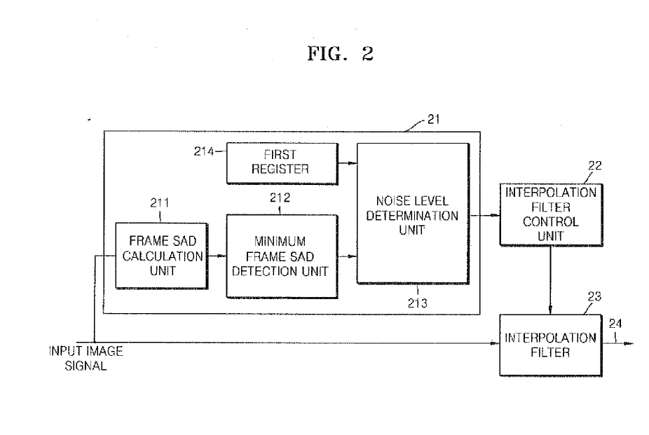

FIG. 2 is a functional block diagram illustrating a structure of an apparatus for converting an image signal.

An apparatus for converting an image signal includes an image noise estimation device 21, an interpolation filter control unit 22, and an interpolation filter 23. The image noise estimation device 21 includes a frame SAD calculation unit 211, a minimum frame SAD detection unit 212, a first register 214, and a noise level determination unit 213.

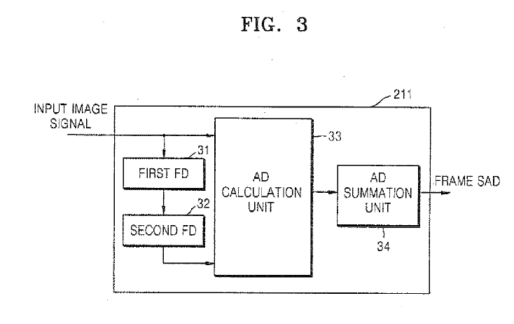

FIG. 3 is a functional block diagram illustrating a structure of a detailed structure of a frame SAD calculation unit 211.

The frame SAD calculation unit 211 includes field delays (FDs) 31 and 32, an absolute difference (AD) calculation unit 33, and an AD summation unit 34.

An image signal of a first field (e.g., A-top field 111) among a sequence of image fields for obtaining the frame SAD is input into the frame SAD calculation unit 211. The input image signal is field-delayed twice through the first and second FDs 31 and 32 and input into the AD calculation unit 33.

At the same time, the AD calculation unit receives the image signal of the second field (e.g., A-top field 113) and calculates an AD of pixel intensity for each pixel or each block.

The AD summation unit 34 sums up the ADs for each field and outputs the sum of the ADs. The sum is referred to as frame SAD (sum of absolute difference). It has to be noted that the pair of fields for obtaining the frame SAD is selected so that the pair of fields has the same phase (top or bottom) (for example, 111-113, 112-121, 113-122, and the like).

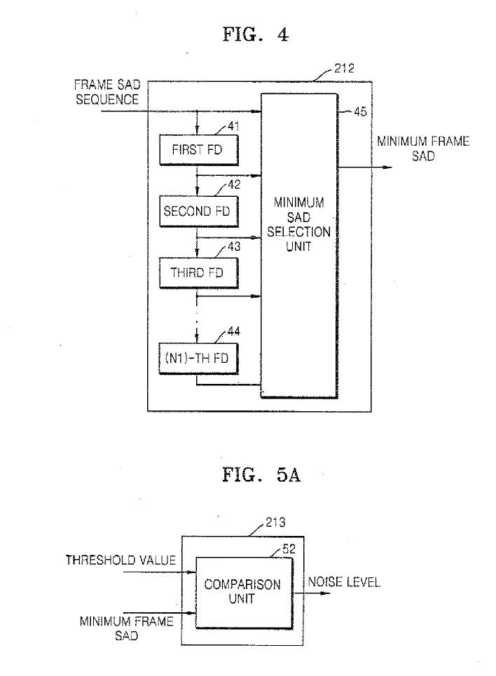

FIG. 4 is a functional block diagram illustrating a detailed structure of a minimum frame SAD detection unit 212.

The minimum frame SAD detection unit 212 includes (N−1)^{th} number of field delay units 41 to 44 and a minimum SAD selection unit 45.

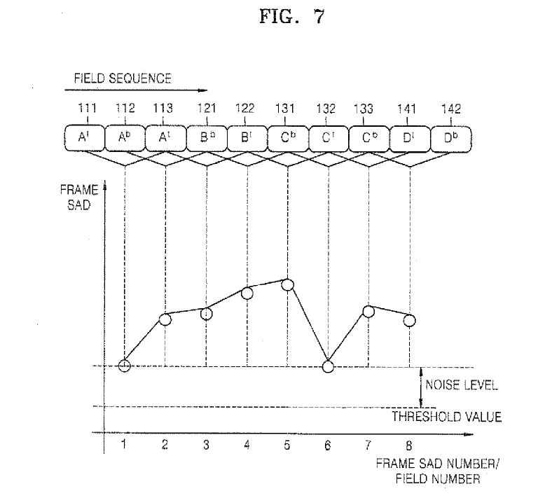

N number of frame SADs which are output from the frame SAD calculation unit 211 are sequentially input into the minimum SAD detection unit 212 and input into the minimum SAD selection unit 45 via the field delay units 0 to N−1. The minimum SAD selection unit selects and outputs the minimum SAD by comparing the magnitudes of the N number of frame SADs. The number N may be selected to be the number of frame SADs which constitutes a period (for example, N=5, in FIG. 7) or the multiples of the number of the frame SADs.

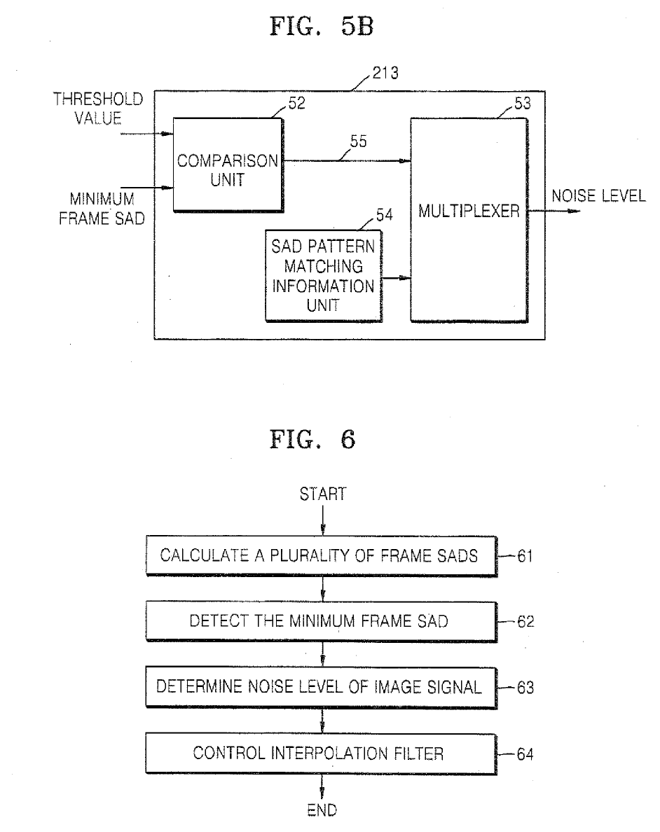

FIGS. 5A and 5B illustrate examples of a detailed structure of a noise level determination unit 213.

The noise level determination unit 213 may include a storage unit, which stores a threshold value and pattern matching information, and a comparison unit.

The noise level determination unit 213 of FIG. 5A includes only the comparison unit 52 and determines a noise level using the difference between the minimum frame SAD and the threshold value. First, when the minimum frame SAD is less than the threshold value, it is determined that the minimum frame SAD is not noise. On the other hand, when the minimum frame SAD is greater than the threshold value, the minimum frame SAD is determined to be noise. The difference between the minimum frame SAD and the threshold value is obtained. An exemplary embodiment of the present invention may include the first register 214 for storing the threshold value. The threshold value is adaptively determined depending on a size of an image and types of image signals (e.g., composite, component, and the like).

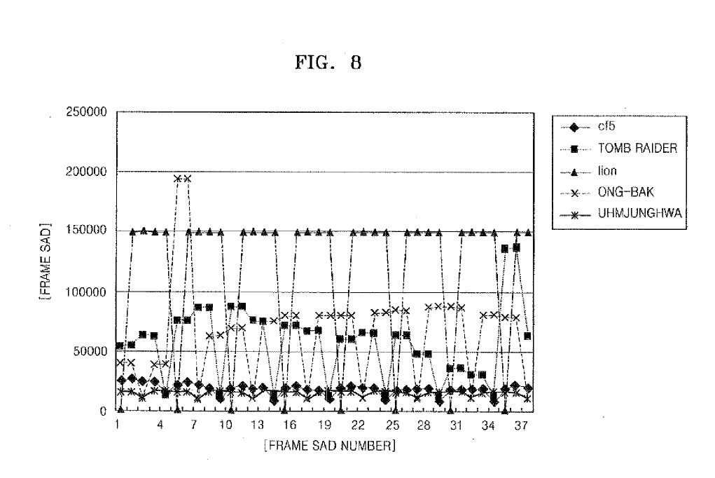

The noise level determination unit 213 of FIG. 5B further includes a SAD pattern matching information unit 54 and a multiplexer 53, in addition to the comparison unit 52. The SAD pattern matching information unit relates to a pattern (for example, FIGS. 7 and 8) of the frame SAD of frame based image fields. The pattern of the output 55 of the comparison unit 52 is compared with the frame SAD pattern. When the pattern of the output 55 is not matched with the SAD pattern, the input image signal is not a frame based image, and therefore the input image signal is ignored.

The interpolation filter 23 in FIG. 2 serves to interpolate an image signal that is input under a control of an interpolation filter control unit. It is understood that the interpolation filter according to an exemplary embodiment of the present invention not only performs interpolation of the input image signal but also performs jitter detection, judder detection, detail enhancement, and the like so as to remove noise such as jitter, judder, and the like from the input image signal.

An image signal 24 of FIG. 2, for example, of an interlaced format that underwent image signal noise estimation and interpolation is transmitted to a deinterlacer (not shown) and converted into an image signal of a progressive format.

FIG. 6 is a flowchart illustrating a method of converting an image signal according to an exemplary embodiment of the present invention. In addition, FIG. 7 illustrates a method of converting an image using fields having a 3:2 pull-down format according to an exemplary embodiment of the method of converting an image signal.

In operation 61, frame SADs are calculated with a plurality of pairs of fields. An operation of selecting two nearest fields having the same phase (top or bottom) and calculating a frame SAD is repeated N times. When the A-top field 111 is selected, the nearest top field is another A-top field 113, and therefore the A-top field 113 is selected. The frame SAD (FSAD1) between the two fields 111 and 113 is obtained. Then, A-bottom field 112 and B-bottom field 121, which is the nearest field having the same phase, are selected and a frame SAD (FSAD2) is obtained using the two fields. A series of frame SADs calculated by repeating the aforementioned method are illustrated in graphs in FIGS. 7 and 8.

The minimum frame SAD is detected in operation 62. As shown in FIG. 7, a plurality of frame SADs repeatedly increases and decreases in a certain period, and the minimum frame SAD included in the period is obtained. In FIG. 7, five frame SADs constitute a period, and the minimum frame SADs (e.g., FSAD1 and FSAD6) periodically show.

In operation 63, a noise level of an image signal is determined by using the minimum frame SAD. As described above, since the minimum frame SADs (e.g., FSAD1 and FSAD2) are calculated from the pair of image fields having the same phase which are extracted from the same image frame, the minimum frame SAD is minimum (ideally zero). When the minimum frame SAD is not zero, the minimum frame SAD corresponds to the noise of the image field. Accordingly, as the difference between the minimum frame SAD and the predetermined threshold value increases, it is determined that the noise level of the image signal increases.

In operation 64, the interpolation filter 23 is controlled by using the noise level.

As described above, the interpolation filter 23 according to an exemplary embodiment of the present invention includes not only a function of interpolation of an input image signal but also functions of jitter detection, judder detection, detail enhancement, and the like so as to remove noise such as jitter, judder, and the like from the input image signal. Accordingly, the function and the performance of the interpolation filter 23 can be changed by adjusting various coefficients of the interpolation filter 23. Accordingly, interpolation filters can be variously controlled based on the noise level obtained from the noise level determination unit. For example, when the noise level is high, the filter coefficient is adjusted so that cadence interpolation which interpolates the original image is weakened, while jitter detection and pixel judder detection is strengthened. In addition, when the noise level is high, the filter coefficient is adjusted so that the detail enhancement sensitive to the noise is weakened.

In addition, it is determined whether noise level increase is temporary by using a noise level history in which the noise levels are recorded for a predetermined period. If the noise level temporarily increases, the noise is ignored and the filter coefficient is not adjusted.

An exemplary embodiment of the present invention provides a method of estimating noise using the minimum frame SAD. Accordingly, it is possible to effectively and accurately estimate noise of a frame based image field.

In addition, noise such as judder, jitter and the like of an image signal is effectively removed by controlling interpolation of the image signal by using the noise level obtained by estimating the noise.

Exemplary embodiments of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in exemplary embodiments of the present invention.

What is claimed is:

1. A device for estimating noise of an image, the device comprising:
a frame sum of absolute difference (SAD) calculation unit which calculates a plurality of frame SADs by using a plurality of image fields;
a minimum SAD detection unit which determines a minimum frame SAD among the plurality of frame SADs calculated by the frame SAD calculation unit; and
a noise level determination unit which determines noise levels of the plurality of image fields by using the minimum frame SAD detected by the minimum frame SAD detection unit.

2. The device of claim 1, wherein the plurality of image fields are frame based fields.

3. The device of claim 1, further comprising a register which stores a threshold value related to said minimum frame SAD.

4. The device of claim 1, wherein the frame SAD calculation unit calculates at least one of the plurality of frame SADs by using two fields having a same phase among the plurality of image fields.

5. The device of claim 1, wherein the frame SAD calculation unit comprises at least one field delay unit, an absolute difference (AD) calculation unit, and an AD summation unit.

6. The device of claim 1, wherein the minimum frame SAD detection unit comprises at least one delay unit and a minimum frame SAD selection unit.

7. The device of claim 1, wherein the noise level determination unit comprises a comparison unit which compares the minimum frame SAD with a predetermined threshold value.

8. The device of claim 1, wherein the noise level determination unit comprises a comparison unit which compares the minimum frame SAD with a predetermined threshold value, a SAD pattern matching information unit, and a multiplexer.

9. The device of claim 1, wherein the minimum frame SAD is obtained from two fields having a same phase which are extracted from a same image frame.

10. The device of claim 3, wherein the threshold value is determined in consideration of at least one of a size of the image and a type of an image signal.

11. The device of claim 7, wherein the predetermined threshold value is determined in consideration of at least one of a size of the image and a type of an image signal.

12. The device of claim 8, wherein the predetermined threshold value is determined in consideration of at least one of a size of the image and a type of an image signal.

13. An apparatus for converting an image signal, the apparatus comprising:
a noise estimation device which determines a noise level by using a minimum frame sum of absolute difference (SAD) detected from a plurality of input image fields;
an interpolation filter which interpolates the plurality of input image fields; and
an interpolation filter control unit which generates a filter coefficient control signal of the interpolation filter by using the noise level determined by the noise estimation device.

14. The apparatus of claim 13, wherein the plurality of image fields are frame based fields.

15. The apparatus of claim 13, wherein the noise estimation device includes an SAD calculation unit, a minimum frame SAD detection unit, and a noise level determination unit.

16. The apparatus of claim 13, wherein the interpolation filter control unit generates a jitter detection control signal.

17. The apparatus of claim 13, wherein the interpolation filter control unit generates a pixel judder detection control signal.

18. The apparatus of claim 13, wherein the interpolation filter control unit generates a detail enhancement control signal.

19. A method of estimating noise of an image signal, the method comprising:
calculating a plurality of frame sum of absolute differences (SADs) by using a plurality of image fields;
determining a minimum frame SAD among the plurality of frame SADs; and
determining the noise level by using the minimum frame SAD.

20. The method of claim 19, wherein the plurality of image fields are frame based fields.

21. The method of claim 19, wherein, in calculating the plurality of frame SADs, at least one of the plurality of frame SADs is calculated by using two fields having a same phase among the plurality of image fields.

22. The method of claim 19, wherein the minimum frame SAD is obtained from two fields having a same phase which are extracted from a same image frame.

23. A method of converting an image signal, the method comprising:
estimating noise by using a minimum frame sum of absolute difference (SAD) detected by using a plurality of input image fields; and
controlling an interpolation filter of the plurality of input image fields by using an estimation result of the noise.

24. The method of claim 23, wherein the plurality of image fields are frame based fields.

25. The method of claim 24, wherein the plurality of image fields have a 3:2 pull-down format.

26. The method of claim 23, wherein the plurality of image fields are obtained by using a 2:3:3:2 cadence pattern technique.

27. The method of claim 23, wherein the estimating the noise comprises:
calculating a plurality of frame SADs by using the plurality of input image fields;
determining the minimum frame SAD among the plurality of frame SADs; and
determining the noise level by using the minimum frame SAD.

28. A computer-readable recording medium having embodied thereon a computer program for executing a method comprising:
calculating a plurality of frame sum of absolute differences (SADs) by using a plurality of image fields;
determining a minimum frame SAD among the plurality of frame SADs; and
determining the noise level by using the minimum frame SAD.

29. A computer-readable recording medium having embodied thereon a computer program for executing a method comprising:
estimating noise by using a minimum frame sum of absolute difference (SAD) detected by using a plurality of input image fields; and
controlling an interpolation filter of the plurality of input image fields by using an estimation result of the noise.
